(19) United States
(12) Patent Application Publication
(10) Pub. No.: US 2018/0242575 A1
(43) Pub. Date: Aug. 30, 2018

(54) AGROCHEMICAL MICROCAPSULES WITH A SHELL OF POLYVINYLALCOHOL AND POLYOXAZOLINE

(71) Applicant: BASF SE, Ludwigshafen am Rhein (DE)

(72) Inventors: Ewelina Burakowska-Meise, Reichenbach (Lautertal) (DE); Valeria Bem, Mannheim (DE); Joanna Mecfel-Marczewski, Limburgerhof (DE); Evgueni Klimov, Ludwigshafen (DE); Klaus Kolb, Schifferstadt (DE); Matthias Bratz, Maxdorf (DE); Steven Bowe, Apex, NC (US); Ronald Repage, Research Triangle Park, NC (US); John Frihauf, Lincoln, NE (US)

(21) Appl. No.: 15/753,278

(22) PCT Filed: Aug. 17, 2016
(86) PCT No.: PCT/EP2016/069455

§ 371 Date: Feb. 17, 2018

Related U.S. Application Data
(60) Provisional application No. 62/206,302, filed on Aug. 18, 2015.

(51) Int. Cl. A01N 25/28; A01N 43/10; A01N 43/90; A01N 37/40; A01N 33/18

(52) U.S. Cl. CPC A01N 25/28; A01N 43/10; A01N 33/18; A01N 37/40; A01N 43/90

(57) ABSTRACT

Provided herein are microcapsules comprising a capsule core and a capsule shell. The capsule shell includes a core surrounding a layer of a polyvinyl alcohol and an adjacent layer of a polyoxazoline, and the capsule core includes a water-insoluble pesticide. Further provided herein is a process for producing the microcapsule, including: a) preparation of an oil-in-water emulsion with a disperse phase which includes the pesticide and an aqueous continuous phase and the polyvinyl alcohol, and b) subsequent addition of one or more of the polyoxazoline. The process relates to a method of controlling phytopathogenic fungi, undesired plant growth, and/or undesired insect or mite attack, and/or for regulating the growth of plants, wherein the microcapsules act on the respective pests, their environment, the crop plants to be protected from the respective pest, on the soil, on undesired plants, on the crop plants, and/or on the environment of each plant.

The present invention relates to microcapsules comprising a capsule core and a capsule shell wherein the capsule shell comprises a core surrounding layer of a polyvinyl alcohol and an adjacent layer of a polyoxazoline, and wherein the capsule core comprises a water-insoluble pesticide. The invention further relates to a process for producing the microcapsule, comprising the process steps: a) preparation of an oil-in-water emulsion with a disperse phase which comprises the pesticide and an aqueous continuous phase and the polyvinyl alcohol, and b) subsequent addition of one or more of the polyoxazoline; and it relates to a method of controlling phytopathogenic fungi and/or undesired plant growth and/or undesired insect or mite attack and/or for regulating the growth of plants, wherein the microcapsules are allowed to act on the respective pests, their environment or the crop plants to be protected from the respective pest, on the soil and/or on undesired plants and/or on the crop plants and/or on their environment. The preferred embodiments of the invention mentioned herein below have to be understood as being preferred either independently from each other or in combination with one another.

Agroformulations of pesticidal microcapsules are very useful products in crop protection.

It is therefore an object of the present invention to find an shell material which is easy to handle and also an advantageous process for producing these agrochemical microcapsules. Microcapsules with such a shell material should if required have a good tightness and offer various options for the release of the agrochemical. It is an aspect of the present invention to provide agrochemical microcapsules which exhibit a good storage stability.

The object was achieved by a microcapsule comprising a capsule core and a capsule shell wherein the capsule shell comprises a core surrounding layer of a polyvinyl alcohol, and an adjacent layer of a polyoxazoline, and wherein the capsule core comprises a water-insoluble pesticide.

Further the object was achieved by a process for producing the microcapsule comprising the process steps:

a) preparation of an oil-in-water emulsion with a disperse phase which comprises the pesticide and an aqueous continuous phase and an polyvinyl alcohol and
b) subsequent addition of one or more polyoxazoline.

The average particle size of the microcapsule (Z-average by light scattering) may be in the range from 0.5 to 80 μm, preferably in the range from 1 to 25 μm and in particular in the range from 2 to 15 μm.

The capsule core comprises a water-insoluble pesticide. For example, the pesticide has a solubility in water of up to 10 g/l, preferably up to 2 g/l, and in particular up to 0.5 g/l, at 20° C. Mixtures of different water-insoluble pesticides are also possible.

The term pesticide usually refers to at least one active substance selected from the group of the fungicides, insecticides, nematicides, herbicides, safeners, biopesticides and/or growth regulators. Preferred pesticides are fungicides, insecticides, herbicides and growth regulators. Especially preferred pesticides are herbicides. Mixtures of pesticides of two or more of the abovementioned classes may also be used. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

The capsule core may optionally comprises a water immiscible organic solvent. Suitable examples for water immiscible organic solvents are
a hydrocarbon solvent such a an aliphatic, cyclic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils));
a vegetable oil, such as corn oil, rapeseed oil;
a fatty acid ester such as C₁-C₁₀-alkylester of a C₁₀-C₂₂-fatty acid; or
methyl- or ethyl esters of vegetable oils such as rapeseed oil methyl ester or corn oil methyl ester.

Mixtures of aforementioned water immiscible organic solvents are also possible. The water immiscible organic solvent is usually commerically available, such as the hydrocarbons under the tradenames Solvesso® 200, Aromatic® 200, or Caromax® 28. The aromatic hydrocarbons may be used as naphthalene depleted qualities. Preferred water immiscible organic solvents are hydrocarbons, in particular aromatic hydrocarbons.

Preferably, the water immiscible organic solvent has a solubility in water of up to 20 g/l at 20° C., more preferably of up to 5 g/l and in particular of up to 0.5 g/l.

Usually, the water immiscible organic solvent has a boiling point above 100° C., preferably above 150° C., and in particular above 180° C.

The weight ratio of the pesticide to the water immiscible organic solvent may be in the range from 20:80 to 95:5, preferably from 30:70 to 90:10, and in particular from 40:60 to 85:15.

When the water immiscible organic solvent is present in the capsule core the pesticide may be dissolved, suspended or emulsified therein. Preferably, when the water immiscible organic solvent is present in the capsule core the pesticide may be dissolved therein.

In one form the capsule core may be solid or liquid (at 20° C.) and comprises at least 95 wt %, preferably at least 98 wt %, and in particular 100 wt % of the pesticide. In another preferred form the capsule core consists of the pesticide.

In another form the capsule core is liquid (at 20° C.) and comprises the water immiscible organic solvent. Preferably, the capsule core is liquid and comprises at least 10 wt % (preferably at least 25 wt %, and in particular at least 40 wt %) of the water immiscible organic solvent and at least 30 wt % (preferably at least 40 wt %) of the pesticide.

The weight ratio of capsule core to capsule shell is generally in the range from 30:70 to 98:2, preferably from 40:60 to 95:5, and in particular from 45:55 to 90:10. In another form the weight ratio of capsule core to capsule shell is generally in the range from 60:40 to 99:1, preferably from 70:30 to 93:7, and in particular from 75:25 to 90:10. The weight of the capsule core is calculated from the sum of the polyvinyl alcohol and the polyoxazoline. The weight of the capsule core is calculated from the sum of the pesticide and, if present, the water immiscible organic solvent.

Preferably the capsule shell consists of a core surrounding layer of a polyvinyl alcohol, preferably an anionic polyvinyl alcohol, and an adjacent layer of a polyoxazoline. The layers may be present in any sequence, or even mixed among each other.

The polyvinyl alcohol used as core surrounding layer of the capsule shell is usually obtainable by polymerization of vinyl acetate, optionally in the presence of comonomers, and hydrolysis of the polyvinyl acetate with elimination of the acetyl groups to form hydroxy groups. The preparation of copolymers of vinyl acetate, and the hydrolysis of these polymers for the formation of polymers comprising vinyl alcohol units are generally known.

The polyvinyl alcohol may be an anionic or a neutral polyvinyl alcohol, wherein the anionic polyvinyl alcohol is preferred.

In one form the polyvinyl alcohol is a neutral polyvinyl alcohol, which are typically free of anionic (e.g. acid groups) or cationic groups. Neutral polyvinyl alcohol may comprise comonomers.

Preferably, neutral polyvinyl alcohol is free of comonomers.

In another form the polyvinyl alcohol is a anionic polyvinyl alcohols. The term ‘anionic polyvinyl alcohol’ usually refers to polyvinyl alcohols which carry acid groups (e.g. according to Broenstedt definition). Depending on the pH of the water phase the acid groups in the polymer are protonated or deprotonated. Anionic polyvinylalcohols are typically copolymers of vinyl alcohol/vinyl acetate and anionic comonomers (comonomers with acid groups).

The acid groups of the anionic polyvinyl alcohol are preferably selected from the group consisting of sulfonic acid groups, phosphonic acid groups and carboxylic acids groups comprising 3 to 8 carbon atoms in a molecule, and/or the alkali metal, alkaline earth metal or ammonium salts thereof.

The anionic polyvinyl alcohol comprises, for example, from 0.1 to 30 mol %, in general from 0.5 to 20 mol %, preferably from 1 to 10 mol % of at least one of anionic comonomers incorporated in the form of polymerized units.

The preferred anionic polyvinyl alcohol according the present invention is obtainable by polymerization of vinyl acetate, optionally in the presence of comonomers carrying acid groups, and hydrolysis of the polyvinyl acetate with elimination of the acetyl groups to form hydroxy groups. The preparation of copolymers of vinyl acetate and the hydrolysis of these polymers to form polymers comprising vinyl alcohol units are generally known.

There are several ways to introduce the acid group. According to one preferred method the acid function is introduced by copolymerization of vinylacetate with a comonomer carrying acid groups preferably selected from monoethylenically unsaturated sulfonic acids, monoethylenically unsaturated phosphonic acids and monoethylenically unsaturated carboxylic acids having 3 to 8 carbon atoms in a molecule and/or the alkali metal, alkaline earth metal or ammonium salts thereof.

Preferred acid groups are selected from the group consisting of sulfonic acid and carboxylic acid having 3 to 8 carbon atoms in a molecule and/or the alkali metal, alkaline earth metal or ammonium salts thereof.

Examples of monomers carrying acid functions which result in the acid groups are ethylenically unsaturated C₃- to C₈-carboxylic acids, such as, for example, acrylic acid, methacrylic acid, dimethacrylic acid, ethacrylic acid, maleic acid, fumaric acid, itaconic acid, mesaconic acid, citraconic acid, methylenemalonic acid, allylacetic acid, vinylacetic acid and crotonic acid. Other suitable monomers of this group are monomers comprising sulfo groups, such as vinylsulfonic acid, acrylamido-2-methylpropanesulfonic acid and styrene sulfonic acid, and monomers comprising phosphonic groups, such as vinyl phosphonic acid. Preferred monomers are itaconic acid, maleic acid, acrylic acid and methacrylic acid. The monomers of this group can be used alone or as a mixture with one another, in partly or in completely neutralized form in the copolymerization. For example, alkali metal or alkaline earth metal bases, ammonia, are used for the neutralization. Examples of these are sodium hydroxide solution, potassium hydroxide solution, sodium carbonate, potassium carbonate, sodium bicarbonate, magnesium oxide, calcium hydroxide, calcium oxide.

Alternatively the acid groups may be introduced into a polyvinyl alcohol by a postmodification reaction.

Preference is given to polyvinyl alcohols, especially anionic polyvinyl alcohol, the viscosity of which for a 4% strength by weight aqueous solution at 20° C. in accordance with DIN 53015 has a value in the range from 1.5 to 70 mPa·s, preferably a value from 15 to 35 mPa·s.

Preference is given to polyvinyl alcohols, preferably anionic polyvinyl alcohol with a degree of hydrolysis of from 60 to 100%, preferably 79 to 95%, in particular 80 to 90% in accordance with DIN 53401.

The polyvinyl alcohols may have a molecular weight from 1 000 to 5 000 000 g/mol, preferably from 5 000 to 1 000 000 g/mol, and in particular from 10 000 to 800 000 g/mol.

Polyvinyl alcohols, especially anionic polyvinyl alcohol with hydrolysis degrees from 85 to 99.9, especially 85% to 95% are preferred, containing 0.1 to 30 mol % comonomers with acid functions like carboxyl- and/or sulfonic acid groups, wherein mol % is based on the polymerization mixture vinyl acetate/comonomer.

Anionic polyvinyl alcohols are sold for example as Mowiol® grades from Kuraray Specialities Europe (KSE).

Preferred are anionic polyvinyl alcohol with a hydrolysis degree of 85.0%-99.5% and a viscosity of 2 mPas-70 mPas. Examples of such type of colloids are: K-Polymer KL-318 from Kuraray (viscosity 20-30 mPas, hydrolysis 85.0-90.0%), Gohsenal T-350 from Nippon Gohsei (viscosity 27-33 mPas, hydrolysis 93.0-95.0%), Gohseran L-3266 from Nippon Gohsei (viscosity 2.3-2.7 mPas, hydrolysis 86.5-89.0%).

Polyoxazolines are commercially available and processes for the preparation of polyoxazolines are known in the art. The polyoxazoline according to the invention is a polymer which comprises (preferably consists of) a polymerized form of oxazoline monomer (A) and optionally one or more further oxazoline monomers (B).

The polyoxazolines preferably have a polydispersity M_{w}/Mₙ, whereas M_{w} refers to the weight average molecular weight and Mₙ refers to the number average molecular weight between 1 and 3. Mₙ of such polyoxazolines is usually between 500 and 500,000, preferably 1,000 and 10,000 and more preferably 1,000 and 5,000.

The polyoxazolines can be in the form of block polymers with controlled block lengths, random copolymers, graft polymers, comb polymers, star polymers, polymers with functional end-groups including, but not limited, to macromonomers and telechelic polymers.

Preferred are oxazoline monomers (A) corresponding to formula (I)

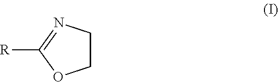

wherein R is selected from hydrogen and linear or branched alkyl.

The additional oxazoline monomer (B) is preferably an oxazoline monomer (B) according to formula (I), wherein R of monomer (B) is selected from hydrogen and linear or branched alkyl, but is different from R of monomer (A).

In a preferred embodiment in the above formula (I), R is selected from hydrogen and linear or branched C₁-C₈ alkyl. R is more preferred selected from hydrogen and linear or branched C₁-C₄ alkyl.

In a more preferred embodiment the oxazoline monomer is selected from methyl oxazoline, ethyl oxazoline, propyl oxazoline, isopropenyl oxazoline and butyl oxazoline. In an even more preferred embodiment the oxazoline monomer is 2-ethyl-2-oxazoline. Further preferred is statistical ethyl-methyl polyoxazoline, for example Poly-(ethyl-stat.-methyl)-oxazoline (4:1)

Polyoxazolines and their preparation are known. The polymerization process may be considered to be a “living polymerization”. In living polymerizations, the polymerization of the monomer progresses until the monomer is virtually exhausted and upon addition of further monomer or a different monomer the polymerization resumes. In living polymerization the degree of polymerization and hence the molecular weight can be controlled by the monomer and initiator concentrations.

In general, the polymerization of oxazoline monomers corresponding to the formula (I) result in a polymer of the following structure:

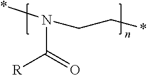

The weight ratio of the polyvinyl alcohol to the polyoxazoline may be in the range from 25:1 to 1:20, preferably from 20:1 to 1:10, and in particular from 15:1 to 1:5.

The present invention further relates to a process for producing the microcapsules comprising the process steps:
a) preparation of an oil-in-water emulsion with a disperse phase which comprises the pesticide and an aqueous continuous phase and the polyvinyl alcohol, preferably the anionic polyvinyl alcohol, and
b) subsequent addition of one or more of the polyoxazoline.

The size of the droplet of the pesticide obtained by distribution is often related to the size of the microcapsule obtained. The size of the droplet of an emulsion is typically substantially reflected as particle diameter of the microcapsule.

The microcapsules may be present in the form of an aqueous dispersion, wherein the fraction of the capsules may be from 1 to 90% by weight, preferably from 5 to 50% by weight.

According to the process of the present invention it is not necessary to add additional surfaceactive substances, such as polymeric protective colloids in order to obtain a stable emulsion.

Protective colloids, which may be ionic or neutral may be added if desired. Preference is given to use organically neutral protective colloids which are preferably water-soluble polymers. Organic neutral protective colloids are, for example, cellulose derivatives such as hydroxyethylcellulose, methylhydroxyethylcellulose, methylcellulose and carboxymethylcellulose, polyvinylpyrrolidone, copolymers of vinylpyrrolidone, gelatin, gum arabic, xanthan, casein, polyethylene glycols and methylhydroxypropylcellulose.

In addition, for costabilization purposes it is possible to add surfactants, preferably nonionic surfactants. Suitable surfactants can be found in the “Handbook of Industrial Surfactants”, to the contents of which reference is expressly made. The surfactants may be used in an amount of from 0.01 to 10% by weight, based on the water phase of the emulsion. In another form the process for producing the microcapsules is achieved in the absence of ionic surfactants.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of

N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

A stable emulsion of core material and polyvinyl alcohol in water is usually prepared with stirring. In this case, stable typically means that it does not result in a doubling of the average droplet size within one hour.

As a general rule, the emulsion is formed at a neutral pH of the water phase, but may also be acidic or alkaline.

Preferably, the dispersing conditions for manufacturing the stable oil-in-water emulsion are selected in a manner known per se such that the oil droplets have the size of the desired microcapsules. Even small capsules, which size is to be below 5 μm, might be obtained by using standard stirring devices such as anchor stirrers or Intermig or propeller stirrers. It is further possible to use homogenizing or dispersing machines, in which case these units may be provided with or without a forced-flow device.

The capsule size may be controlled within certain limits via the rotational speed of the dispersing device/homogenizing device and/or with the support of the concentration of the protective colloid or via its molecular weight, i.e. via the viscosity of the aqueous continuous phase. In the context of the present invention the size of the dispersed droplets decreases, since the rotational speed increases up to a limiting rotational speed.

In this connection the dispersing devices are preferably used at the start of capsule formation. In the case of continuously operating devices with forced flow it is advantageous to send the emulsion several times through the shear field.

In order to disperse highly viscous thermally stable media the preparation of the emulsion takes place within a temperature range from 30 to 130° C., preferably 40 to 100° C.

As a rule, the coacervation is carried out at 15 to 100° C., preferably at 20 to 40° C. Depending on the pesticide the oil-in-water emulsion is usually formed at a temperature at which the core material is liquid.

As a rule the preparation of the emulsion takes place at a pH from 1 to 7, preferably 2 to 5. It is further preferred to add the one or more polyoxazolines at a pH from 1 to 7, preferably 2 to 5.

Preferably the amount of the core material is from 1 to 50% by weight, preferably 5 to 40% by weight, based on the resulting microcapsule dispersion which equals the amount of all ingredients.

In a preferred process the oil-in-water emulsion comprises 0.1 to 10% by weight, preferably 1 to 5% by weight, more preferably 2 to 5% by weight, of polyvinyl alcohol, preferably anionic polyvinyl alcohol.

It is further preferred to add 0.1 to 10% by weight, preferably 1 to 5% by weight, more preferably 2 to 5% by weight based on the oil-in-water emulsion, of a polyoxazoline.

A preferred process for producing microcapsules comprises the process steps:
a) preparation of an oil-in-water emulsion with a disperse phase which comprises the pesticide and an aqueous continuous phase and 0.1 to 10% by weight, based on the oil-inwater emulsion, of the anionic polyvinyl alcohol and
b) subsequent addition of 0.1 to 10% by weight, based on the oil-in-water emulsion, of one or more of the polyoxazoline.

The present invention further relates to aqueous dispersions comprising 5 to 50% by weight, based on the total weight of the dispersion, preferably from 15 to 40% by weight, of the microcapsules. A further preferred range is between 20 and 35% by weight. These aqueous dispersions are preferably obtained directly from the process described above.

The aqueous dispersion may comprise a non-encapsulated pesticide. This non-encapsulated pesticide may be present in dissolved form, or as a suspension, emulsion or suspoemulsion. It may be identical or different to the pesticide in the capsule core. The aqueous dispersion may comprise the non-encapsulated pesticide in the aquous phase. The aqueous composition contains usually at least 1 wt % non-encapsulated pesticide, preferably at least 3 wt % and in particular at least 10 wt %.

The aqueous dispersion may comprise further auxiliaries outside the microcapsules, e.g. in the aqueous phase of the aqueous dispersion. Examples for suitable auxiliaries are solubilizers, penetration enhancers, adhesion agents, thickeners, humectants, repellents, attractants, feeding stimulants, compatibilizers, bactericides, anti-foaming agents, colorants, tackifiers and binders.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-foaming agents are silicones, long chain alcohols, and salts of fatty acids.

The invention also relates to a method of controlling phytopathogenic fungi and/or undesired plant growth and/or undesired insect or mite attack and/or for regulating the growth of plants, wherein the microcapsules are allowed to act on the respective pests, their environment or the crop plants to be protected from the respective pest, on the soil and/or on undesired plants and/or on the crop plants and/or on their environment.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (dessert grapes and grapes for vinification); hops; grass, for example turf; sweetleaf (Stevie rebaudania); rubber plants and forest plants, for example flowers, shrubs, deciduous trees and coniferous trees, and propagation material, for example seeds, and harvested produce of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such recombinant modifications also comprise posttranslational modifications of proteins, oligo- or polypeptides, for example by means of glycosylation or binding polymers such as, for example, prenylated, acetylated or farnesylated residues or PEG residues.

The user applies the microcapsules or the aqueous dispersion usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Various types of oils, wetters, adjuvants, fertilizer, or micronutrients, and further pesticides (e.g. herbicides, insecticides, fungicides, growth regulators, safeners) may be added to the the agrochemical compositions comprising them as premix or, if appropriate not until immediately prior to use (tank mix). These agents can be admixed with the compositions according to the invention in a weight ratio of 1:100 to 100:1, preferably 1:10 to 10:1.

When employed in plant protection, the amounts of pesticide applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required.

The invention offer various advantages: The encapsulation process is based on preformed polymers, thus no dangerous monomers such as isocyanates or acrylates must be handled; the microcapsules have a verly low phytotoxicity; the microcapsules allow a very fast release of the pesticide, typically already during the drying of the aqueous dispersion on the plants or the pests; the production proves is very easy and cheap and fast; during the production no new polymers are formed, which might required additional registration; the pesticide may have reactive groups (e.g. double bonds, hydroxy or amine groups) which may not be present in other encapsulation techniques (e.g. polyurea or polyurethane or poly(meth)acrylate microcapsules).

### EXAMPLES

The particle size of the microcapsule dispersion was determined using a Malvern Particle Sizer model 3600E or a Malvern Mastersizer 2000 in accordance with a standard measuring method which is documented in the literature. The D[v, 0.1] value means that 10% of the particles have a particle size (in accordance with the volume average) up to this value. Accordingly, D[v, 0.5] means that 50% of the particles and D[v, 0.9] means that 90% of the particles have a particle size (according to the volume average) less than/equal to this value.

Viscosity values of PVAs are the values of a 4 weight % aqueous solution determined at 20° C. by Brookfield viscometer.

### Example 1

A premix (I) containing 12.5 g of itaconic acid-modified anionic PVA (CAS number 122625-12-1; Mowiol® KL-318, Kuraray with hydrolysis degree 85%-90% and visc. 20.0-30.0 mPas) and 274 g of water was prepared. Next it was poured into 150 g of dimethenamid-p herbicide and emulsified with the help of a Mig stirrer at room temperature for 30 minutes at a speed of 800 rpm.

Premix (II) containing 19.2 g of (Poly-(ethyl-stat.-methyl)-oxazoline (4:1)) and 18 g of water was prepared.

Premix (II) was next added to the emulsion of premix (I) and dimethenamid-p over the course of 5 minutes. The reaction mixture was then stirred at room temperature for 30 minutes resulting in the desired microcapsule dispersion with a particle size distribution according to the following values: d 50=7 μm and d 90=12 μm.

### Example 2

Example 1 was repeated using another polyoxazoline, namely poly(2-ethyl-2-oxazoline) (Mₙ=50 000 g/mol). The particle size distribution was d 50=5 μm and d 90=11 μm.

### Example 3

A premix (I) was prepared from 42 g of itaconic acid-modified anionic PVA (Mowiol® KL-318) and 62 g of water. The premix (I) was next poured into 50 g of cinmethylin herbicide and emulsified with help of a high shear stirrer for 1 minute at room temperature and a speed of 20000 rpm.

Premix (II) was prepared from 3.6 g of poly(2-ethyl-2-oxazoline) (Mₙ=50 000 g/mol) and 30 g of water.

It was next added to the formed emulsion of premix (I) and cinmethylin over the course of 5 minutes. The reaction mixture was then stirred for 30 minutes at 800 rpm giving the desired microcapsule dispersion with a particle size distribution according to the following values: d 50=4 μm and d 90=9 μm.

### Example 4

Example 3 was repeated using another polyoxazoline, namely poly(2-ethyl-2-oxazoline) (Mₙ=200 000 g/mol). The particle size distribution was d 50=4 μm and d 90=9 μm.

### Example 5

Example 3 was repeated using another polyoxazoline, namely poly(2-ethyl-2-oxazoline) (Mₙ=500 000 g/mol). The particle size distribution was d 50=4 μm and d 90=9 μm.

### Example 6

A premix (I) containing 12.5 g of itaconic acid-modified anionic PVA (Mowiol® KL-318, Kuraray with hydrolysis degree 85%-90% and visc. 20.0-30.0 mPas) and 274 g of water was prepared.

Premix (II) containing 80 g dicamba acid and 80 g Myritol® 318 oil (caprylic/capric triglyceride) was prepared. The two premixes were then combined and emulsified for 30 minutes at room temperature at a speed of 800 rpm.

Premix (III) containing 19 g of (poly-(ethyl-stat.-methyl)-oxazolin(4:1)) and 18 g of water was prepared.

Premix (III) was next added (over the course of 5 minutes) to the emulsion of premix (I) and (II). The reaction mixture was then stirred at room temperature for 30 minutes giving the desired microcapsule dispersion with a particle size distribution according to the following values: d 50=4 μm and d 90=7 μm.

### Example 7

A premix (I) containing 12.5 g of itaconic acid-modified anionic PVA (Mowiol® KL-318, Kuraray with hydrolysis degree 85%-90% and visc. 20.0-30.0 mPas) and 274 g of water was prepared.

Premix (II) containing 128 g dicamba acid and 32 g mineral oil was prepared. The two premixes were then combined and emulsified for 10 minutes at room temperature at a speed of 800 rpm.

Premix (III) containing 19 g of poly(2-ethyl-2-oxazoline) (Mₙ=500 000 g/mol) and 18 g of water was prepared. Premix (III) was next added (over the course of 5 minutes) to the emulsion of premix (I) and (II). The reaction mixture was then stirred at room temperature for 30 minutes giving the desired microcapsule dispersion with a particle size distribution according to the following values: d 50=17 μm and d 90=23 μm.

### Example 8

A premix (I) containing 12.5 g of itaconic acid-modified anionic PVA (Mowiol® KL-318, Kuraray with hydrolysis degree 85%-90% and visc. 20.0-30.0 mPas) and 274.2 g of water was prepared. It was heated to 60° C., poured into 150 g of pendimethalin and emulsified with the help of a stirrer for 30 minutes at 60° C. and a speed of 800 rpm.

Premix (II) containing 30 g of (poly-(ethyl-stat.-methyl)-oxazolin(4:1)) and 35.6 g of water was prepared and heated to 60° C.

Premix (II) was next added over the course of 5 minutes to the emulsion of premix (I) and pendimethalin. The reaction mixture was then stirred at room temperature for 30 minutes giving the desired microcapsule dispersion with a particle size distribution according to the following values: d 50=6 μm and d 90=11 μm.

### Example 9

Example 8 was repeated using another polyoxazoline, namely poly(2-ethyl-2-oxazoline) (Mₙ=500 000 g/mol). The particle size distribution was d 50=5 μm and d 90=11 μm.

### Examples 10 to 13

Example 1 with dimethenamid-p herbicide, Example 3 with cinmethylin herbicide, Example 6 with dicamba acid, and Example 8 with pendimethalin were each repeated using another polyvinyl alcohol at the same amount, namely neutral polyvinyl alcohol (Mowiol® 18-88, Kuraray, with hydrolysis degree of 86.7 to 88.7, viscosity 16.5-19.5 mPas (DIN53015)). The resulting microcapsule dispersions had a similar particle size.

1. A microcapsule comprising a capsule core and a capsule shell,
wherein the capsule shell comprises a core surrounding a layer of a polyvinyl alcohol and an adjacent layer of a polyoxazoline, and
wherein the capsule core comprises a water-insoluble pesticide.

2. The microcapsule according to claim 1, wherein the polyvinyl alcohol is one of an anionic and a neutral polyvinyl alcohol.

3. The microcapsule according to claim 2, wherein the polyvinyl alcohol is an anionic polyvinyl alcohol.

4. The microcapsule according to claim 1, wherein the weight ratio of capsule core to capsule shell is from 40:60 to 95:5.

5. The microcapsule according to claim 1, wherein the polyvinyl alcohol is an anionic polyvinyl alcohol comprising acid groups that are selected from the group consisting of sulfonic acid groups, phosphonic acid groups and carboxylic acids groups having 3 to 8 carbon atoms in a molecule, alkali metal salts thereof, alkaline earth metal salts thereof, and ammonium salts thereof.

6. The microcapsule according to claim 5, wherein the polyvinyl alcohol is an anionic polyvinyl alcohol comprising acid groups that are selected from the group consisting of itaconic acid, maleic acid, acrylic acid, and methacrylic acid.

7. The microcapsule according to claim 1, wherein the polyvinyl alcohol is an anionic polyvinyl alcohol with a degree of hydrolysis of from 60% to 100%.

8. The microcapsule according to claim 1, wherein the polyoxazoline consists in polymerized form of an oxazoline monomer (A) according to formula (I) 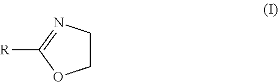
wherein R is selected from the group consisting of hydrogen, linear alkyl, and branched alkyl.

9. The microcapsule according to claim 8, wherein R is selected from one of linear and branched C₁-C₄ alkyl.

10. The microcapsule according to claim 1, wherein the capsule core comprises a water immiscible organic solvent.

11. The microcapsule according to claim 1, wherein the capsule core consists of the pesticide.

12. The microcapsule according to claim 1, wherein the average particle size of the microcapsule is a Z-average by light scattering and is in the range from 1 μm to 25 μm.

13. A process for producing the microcapsule as defined in claim 1, comprising:
a) preparing an oil-in-water emulsion with a disperse phase including the pesticide, an aqueous continuous phase, and the polyvinyl alcohol, and
b) subsequently adding of one or more of the polyoxazoline.

14. An aqueous dispersion comprising 5 to 50% by weight, based on the total weight of the dispersion, of the microcapsules as defined in claim 1.

15. A method for at least one of controlling phytopathogenic fungi, undesired plant growth, and undesired attacks by one of insects and mites and regulating the growth of plants, the method comprising applying the microcapsules as defined in claim 1 on at least one of pests, an environment of the pests, crop plants to be protected from the pests, soil, undesired plants, and an environment of the crop plants.

16. The microcapsule according to claim 8, wherein the polyoxazoline further comprises one or more oxazoline monomer (B) of formula (I), wherein R of monomer (B) is selected from the group consisting of hydrogen, linear alkyl, and branched alkyl and is different from the R of monomer (A).
